(19) United States
(12) Patent Application Publication
(10) Pub. No.: US 2010/0154260 A1
(43) Pub. Date: Jun. 24, 2010

(54) CALENDAR HAVING REPOSITIONABLE, DUAL IMPRESSION LABELS

(76) Inventor: Anna B. Franco, Old Brookville, NY (US)

Correspondence Address: MICHAEL J. PORCO, P.O. BOX 1341, BAYVILLE, NY, 11709, US

(21) Appl. No.: 12/340,719

(22) Filed: Dec. 21, 2008

(51) Int. Cl. G09D 3/04

(52) U.S. Cl. 40/119

(57) ABSTRACT

A calendar having repositionable, dual impression labels for each day of the month is provided. The calendar of the present disclosure includes a plurality of pages, each page includes indicia for one month of the calendar year. Each page includes a plurality of boxes indicating each day of the month. Disposed over each box is a label, note, tag or the like. Each label is constructed of dual impression paper wherein upon a user writing on the label, a first impression will result on a first surface of the label and a second impression will be transferred to a surface of the calendar page directly beneath the label. The label is also repositionable, i.e., the label can be removed and attached to a different surface or the original surface.

### BACKGROUND

1. Field

The present disclosure relates generally to calendars and messaging systems, and more particularly, to a calendar having repositionable, dual impression labels for each day of the month.

2. Description of the Related Art

Calendars, in their basic form, provide written tables displaying days and months of the future. Many calendars are provided with a small amount of space surrounding indicia corresponding to each day, which space is available for writing of notes which will serve the writer or others as a reminder or other advisement of future events, obligations, and the like.

Many users employ a calendar for reminders and to generate to-do lists to be accomplished on a particular day. However, often after inscribing the reminder or to-do list on the calendar, the user will often forget what they had written on the calendar while they are out and about. While small pocket calendars are known in the art, use of such pocket calendars would require the user to inscribe the information twice, which would most likely result in the user only employing the pocket calendar out of convenience. However, with the busy schedules of contemporary families, a conventional wall calendar is still required in many homes to juggle the schedules of all the family members and to serve as a central location for information viewable for each member of the family.

Therefore, a need exists for a calendar or messaging system which creates a permanent record of information transcribed upon viewable to a plurality of users and a portable record which carries identical information to that of the permanent record.

### SUMMARY

A calendar having repositionable, dual impression labels for each day of the month is provided. The calendar of the present disclosure includes a plurality of pages, each page includes indicia for one month of the calendar year. Each page includes a plurality of boxes indicating each day of the month. Disposed over each box is a label, note, tag or the like. Each label is constructed of dual impression paper wherein upon a user writing on the label, a first impression will result on a first surface of the label and a second impression will be transferred to a surface of the calendar page directly beneath the label. The label is also repositionable, i.e., the label can be removed and attached to a different surface or the original surface.

In use, a message or information is entered once for the particular day, but a permanent record (i.e., the calendar page) and a portable record (i.e., the label) is created, thus saving the user time by only having to write the information once. In this manner, a user may transcribe onto a label for a particular date a to-do list for that day. The user may then remove the label and take it with them when performing the tasks on the to-do list. Upon return to the calendar, the user may reposition the label onto the calendar to confirm all tasks were completed and have a permanent record of the completed tasks.

According to one aspect of the present disclosure, a calendar is provided including a plurality of calendar pages each having indicia thereon defining a plurality of discrete spaces, one for each day of the month, each space having date indicia on the front side thereof, a plurality of labels adapted to be releaseably adhered to each of said plurality of discrete spaces, each label fitting within one of said spaces, each said label having date indicia printed on one side thereof to corresponding to said date indicia of said space, each said label configured to impart a duplicate image upon said corresponding space of said calendar page when written upon with a writing implement. The calendar includes a separate page for each month.

In another aspect, each of said plurality of labels is a pressure-sensitive copying paper.

In a further aspect, each of said plurality of labels includes a pressure sensitive adhesive on at least a portion of a back surface of each label.

In yet another aspect of the present disclosure, each of the plurality of labels includes preprinted lines or preprinted lines and associated check boxes.

In still another aspect of the present disclosure, each label includes at least two stacked labels disposed over each discrete space to form a plurality of portable records.

In another aspect of the present disclosure, a calendar includes a rectangular backing sheet made of relatively flexible material; a plurality of rectangular calendar sheets made of relatively flexible material, all of said calendar sheets being of substantially the same size as said backing sheet, each calendar sheet representing one month of the year; means fastening all said sheets together along one edge thereof, whereby said one edge may be utilized for suspending the calendar; each of said calendar sheets having individual date spaces arranged in vertical columns and horizontal rows to provide the dates for one month; a plurality of labels adapted to be releaseably adhered to each of said individual date spaces, each label fitting within one of said individual date spaces, each said label configured to impart a duplicate image upon said corresponding individual date space of said calendar page when written upon with a writing implement.

In yet another aspect of the present disclosure, a calendar includes at least one calendar page each having indicia thereon defining at least one month of the calendar year; the at least one calendar page comprises a two-ply form including a face stock having top and bottom surfaces, a release liner of the same size and shape as the face stock and underlaying the face stock and adhesive on the bottom surface of the face stock releasably securing the face stock to the release liner; the face stock and liner being of such material that upon writing information on said face with a writing implement, a copy of that information is simultaneously made on said liner; wherein the face stock includes a label for each day of the month defined by a plurality of horizontal and vertical cuts through the face stock so that each individual day label is removable from the release liner and the remainder of the face stock, each individual day label having date indicia on the front side thereof and a corresponding date indicia is disposed on the liner directly underneath the individual day label.

In a further aspect, each individual day label includes preprinted blank lines and associated check boxes to define a to-do list, wherein upon a user writing on each preprinted blank line of a particular individual day label, a substantially identical copy of the user-defined to-do list is transferred to the liner underneath the particular individual day label.

In still another aspect, the at least one calendar page includes a three-ply form including two layers of face stock wherein each layer of face stock includes a label for each day of the month defined by a plurality of horizontal and vertical cuts through the two layers of face stock so that two individual day labels are removable from the release liner and the remainder of the face stock.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a plan view of a calendar in accordance with an embodiment of the present disclosure;

FIG. 2 is a detailed view of the calendar shown in FIG. 1 with a label corresponding to a particular date removed;

FIG. 3 is a detailed view of the calendar shown in FIG. 1 with a label to be repositioned on the calendar;

FIGS. 4A-C illustrate several views of a repositionable, dual impression label in accordance with an embodiment of the present disclosure;

FIG. 5 is a detail view of a calendar with a repositionable, dual impression label in accordance with another embodiment of the present disclosure; and

FIGS. 6A-B illustrate various labels in accordance with the present disclosure.

The appended drawings illustrate exemplary embodiments of the present disclosure and, as such, should not be considered as limiting the scope of the disclosure that may admit to other equally effective embodiments. Correspondingly, it has been contemplated that features or steps of one embodiment may beneficially be incorporated in other embodiments without further recitation.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

Referring now to the drawings, there is shown generally at 10 calendar including a plurality of calendar pages shown generally at 12. The plurality of pages 12 are releaseably retained in the calendar by rings 14 although any other suitable binding or fastening means may be employed for retaining the pages 12, for example, a spiral bound member, staples, clips, etc . . . . The sheets 12 also comprise apertures 16 for receiving the rings 14. It is to be appreciated that the binding or fastening means may be utilized for suspending or hanging the calendar. It is further to be appreciated that the calendar may include a backing sheet in addition to a calendar sheet for each month.

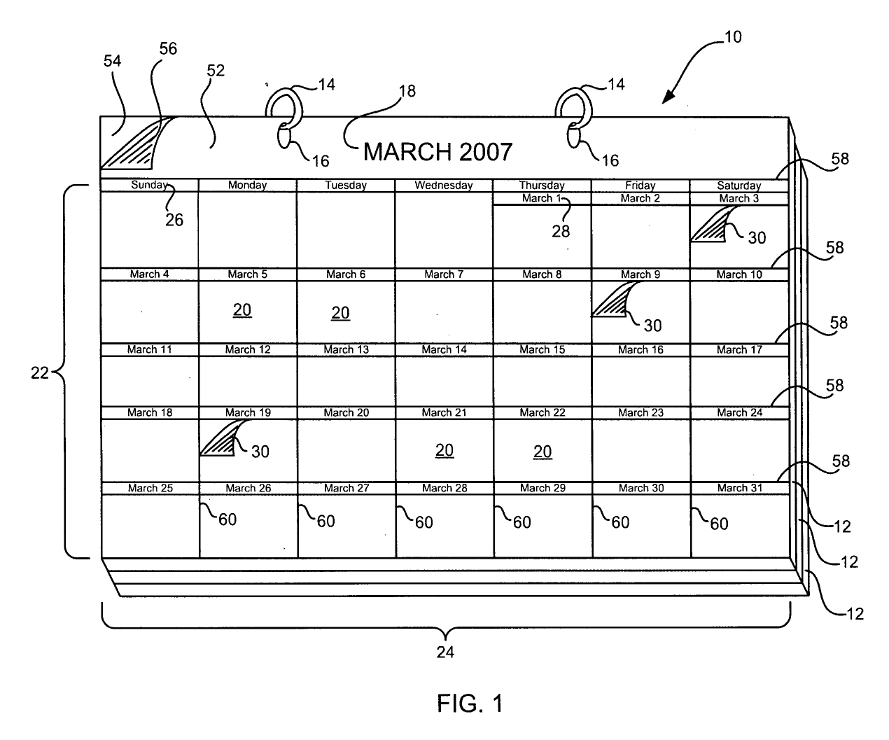

The calendar 10 preferably comprises twelve of the calendar pages 12, one for each month, and the pages 12 are each constructed of a substantially heavy weight, flexible material. As seen in FIG. 1, the front side of each calendar sheet 12 has indicia 18 thereon designating a month of the year and further indicia defining a plurality of daily squares or blocks 20. As will be noted, there are five horizontal rows 22 of the squares 20, each row comprising seven squares 24, as is conventionally the case in a monthly calendar. Each vertical row 24 of squares carries a day of the week identification 26 at the top of each vertical row, all as is conventional in the normal monthly calendar. Each square 20 includes indicia indicating the numerical date 28.

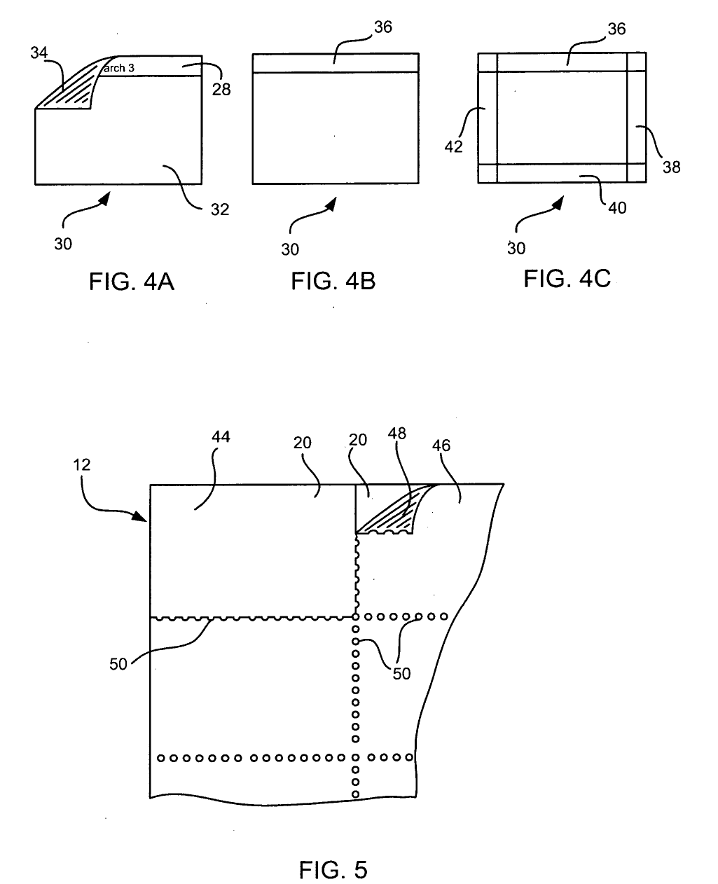

Referring now to FIGS. 1-4, a label 30 is provided and adapted to be releaseably attached to each square or block 20. It will be understood that the label 30 is dimensioned and configured so as to fit within each block or square 20, although the exact shape of the label 30 is unimportant. The labels 30 are attachable and removeable from the pages 12 by any conventional pressure sensitive adhesive means, e.g., a low-tack reusable adhesive, or other means, the details of which will be described below. Each label 30 includes a front surface 32 and a back surface 34, wherein upon writing on the front surface 32, an exact copy of what is written in transferred and viewable upon the surface of the calendar page.

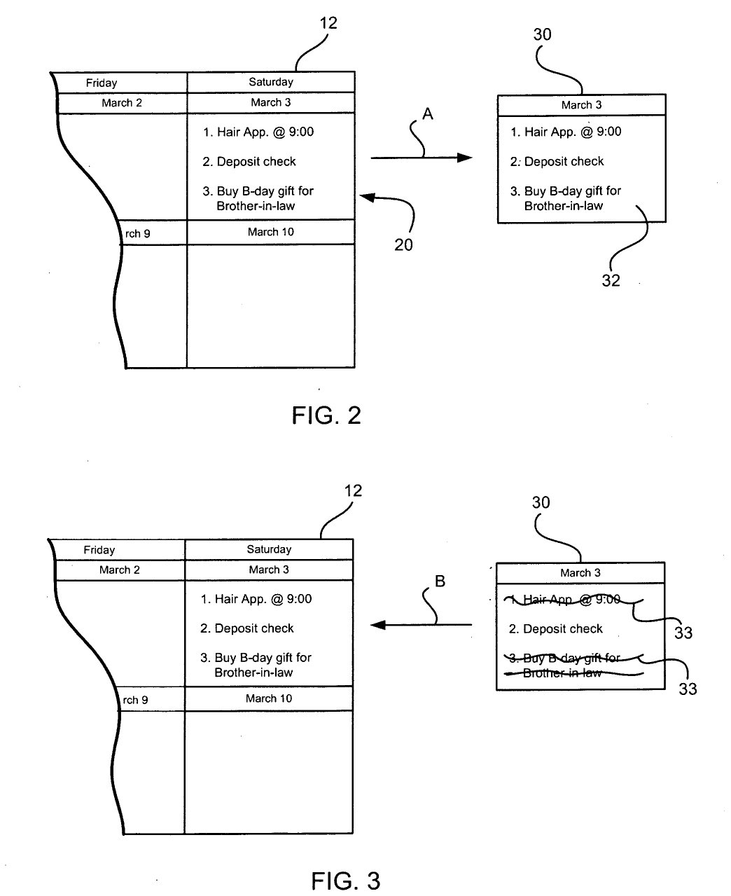

As best shown in FIG. 2, a user may write or impart some other impression by, for example, a pen, pencil or other writing instruments, onto the front surface 32 of the label 30. In the example shown in FIGS. 2 and 3, the user has created a to-do list for the particular date, i.e., March 3. It is to be appreciated the to-do list will be transferred to the box 20 of the corresponding date on the calendar page 12. Upon removal of the label 30 as indicated by arrow A, the underlying box 20 will be exposed revealing an identical copy of what was written on the label. In this manner, the user has two records of the information that was written on the label 30: (1) a permanent record on the box 20 of the corresponding date on the calendar page 12 and (2) a portable record on the label 30 which the user can carry with them in attempting to accomplish the tasks on the to-do list.

It is to be further appreciated that the label 30 is repositionable, i.e., the label 30 can be reapplied to a surface such as the calendar page 12. For example, as illustrated in FIG. 3, as a user completes the tasks on the created to-do lists, the user may check off or cross off the completed tasks 33. Upon returning to the calendar 10, the user can reapply or reattach the label 30, as indicated by arrow B, to the calendar page 12 to cross referenced what was completed.

Each label 30 may be of any know transfer-onto-plain paper type of pressure-sensitive copying paper known in the art, e.g., carbonless copy paper. An exemplary pressure-sensitive copying paper is disclosed in U.S. Pat. No. 4,435,471 to Matsushita et al., the contents of which are hereby incorporated by reference in their entirety. Matsushita et al. describes a transfer-onto-plain paper type of colorless pressure-sensitive copying paper excellent in plain paper-transferability and color forming properties, by coating the back of a substrate with a single layer containing a metal compound, ligand, and wax, both or either one of the metal compound and ligand being capsulated. Upon pressure being applied to a top surface of the substrate by a writing pen or the like, the capsules rupture transferring a reproduced image to an underlying substrate, e.g., a plain paper. Exemplary metal compounds, ligands, and waxes are disclosed in said U.S. Pat. No. 4,435,471.

Furthermore, each label 30 will have a re-adherable or repositionable adhesive on at least a portion of its back surface. An exemplary adhesive is disclosed in U.S. Pat. No. 3,691,140 to Silver, entitled “Acrylate copolymer microspheres”, the contents of which are hereby incorporated by reference. It is to be appreciated the subject adhesive of U.S. Pat. No. 3,691,140 is employed in conventional Post-it™ notes commercially available from 3M of St. Paul, Minn.; however, other re-adherable or repositionable adhesives may be employed in accordance with the teachings of the present disclosure. Such exemplary low-tack adhesives are desirable since such adhesives can be easily attached to a surface, removed and re-attached without leaving marks or residue.

In one embodiment, each label 30 will have a partial adhesive coating on the back surface 34 along one edge, e.g., an upper horizontal edge 36. In other embodiments, all four edges 36, 38, 40, 42 of the back surface of the label 30 will include adhesive, e.g., a strip portion.

In another embodiment as best shown in FIG. 5, each calendar page 12 comprises two layers including a backing layer 44 forming the rear layer of the page and a front layer 46 which is of a thinner paper material which can be torn away from the backing layer 44. The front layer 46 includes an adhesive rear surface 48 and is divided into the boxes 20 by lines of perforation indicated at 50. As shown thus in FIG. 5 some of the perforations have been torn so that a first one of the front sheets has been torn away from the box 20 whereas the next lower rectangle the front sheet remains intact and the next rectangle to the right again the front sheet remains intact. In this case however the corner is turned over to commence the removal process in showing the adhesive layer 48 on the rear surface. The adhesive layer is of the type which can be removed and reapplied so that the label defined by the front sheet can be removed and applied to another surface for example a mirror or the desk of the user to act as a reminder. It is to be appreciated the back surface of the front layer 46 will includes a coating to reproduce an image or writings inscribe on the front layer onto the backing layer 44, e.g., to achieve carbon-less copying.

In another embodiment, the page 12 of the calendar 10 is constructed as a two-ply form including a face stock 52 having top and bottom surfaces, a release liner 54 of the same size and shape as the face stock 52 and underlaying the face stock 52, and adhesive 56 on the bottom surface of the face stock 52 releasably securing the face stock to the release liner 54. The face stock 52 and liner 54 are of such material that, upon writing information on the top surface of face stock 52 with an impression writing instrument such as a pencil, pen, typewriter, dot matrix or any impact printer, or the like, a copy of that information is simultaneously made on the liner 54. An exemplary two-ply form is commercially available from Fasson Role Division of Avery Dennison Corp. in Painsville, Ohio. Other suitable two-ply form with an adhesive backed top ply and data transfer capability between plies may be used. In this embodiment, the face stock 52 includes the label 30 which is at least partially designed by a plurality of cuts 58, 60 through the face stock 52 so that the label 30 is removable from the release liner 54 and the remainder of the face stock 52 so that it can be attached by the adhesive 56 on the bottom surface thereof to another surface such as a calendar page. The cuts include a plurality of horizontal cuts 58 and a plurality of vertical cuts 60 which define each label.

In a further embodiment, each calendar page includes a three-ply form including two layers of face stock wherein each layer of face stock includes a label for each day of the month defined by a plurality of horizontal and vertical cuts through the two layers of face stock so that two individual day labels are removable from the release liner and the remainder of the face stock for each day of the month.

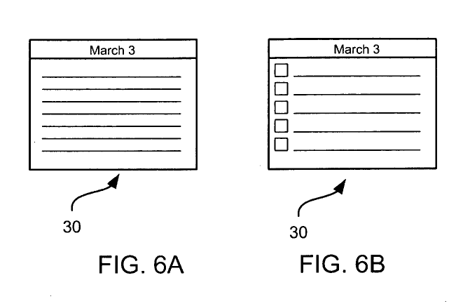

Although the label 30 of the present disclosure is shown as being substantially blank, each label 30 may include preprinted matter. For example, each label 30 may include a plurality of lines to guide a user in writing upon, as shown in FIG. 6A. Furthermore, the label 30 may be preprinted with lines and associated checkboxes to assist a user in keeping track of completed items, for example as with a to-do list, as shown in FIG. 6B. It is to be appreciated that each label may include other indicia such as holidays or other pre-defined special days such as birthdays, anniversaries or the like.

In a further embodiment, a label 30 is constructed of a plurality of stacked carbon-less, repositionable self-adhesive paper to create a plurality of portable records. Exemplary stacked carbon-less, repositionable self-adhesive paper is disclosed in U.S. Pat. No. 5,756,187 to Kuo et al. Each stack will be disposed over each box 20 and a plurality of portable records will be created upon writing on any one label. In this manner, a user may create a portable record for each member of a family wherein each member may be assigned a task. The number of labels in each stack may vary and may be selected based on the number of members in a family or household.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A calendar comprising:
a plurality of calendar pages each having indicia thereon defining a plurality of discrete spaces, one discrete space for each day of the month, each space having date indicia on the front side thereof,
a plurality of labels adapted to be releaseably adhered to each of said plurality of discrete spaces, each label fitting within one of said spaces, each said label having date indicia printed on one side thereof to corresponding to said date indicia of said space, each said label configured to impart a duplicate image upon said corresponding space of said calendar page when written upon with a writing implement.

2. The calendar of claim 1, further comprising a separate page for each month.

3. The calendar of claim 1, wherein each of said plurality of labels is a pressure-sensitive copying paper.

4. The calendar of claim 3, wherein each of said plurality of labels includes a pressure sensitive adhesive on at least a portion of a back surface of each label.

5. The calendar of claim 1, wherein each calendar page comprises a backing layer forming a rear layer of the page and a front layer defining the plurality of labels, wherein the front layer includes an adhesive rear surface and is divided into the plurality of discrete spaces by lines of perforation.

6. The calendar of claim 1, wherein each calendar page comprises a two-ply form including a face stock having top and bottom surfaces, a release liner of the same size and shape as the face stock and underlaying the face stock and adhesive on the bottom surface of the face stock releasably securing the face stock to the release liner, wherein the face stock defines the labels by a plurality of cuts through the face stock so that the label is removable from the release liner and the remainder of the face stock.

7. The calendar of claim 1, wherein each of the plurality of labels includes preprinted lines.

8. The calendar of claim 1, wherein each of the plurality of labels includes preprinted lines and associated check boxes.

9. The calendar of claim 1, wherein each label includes at least two stacked labels disposed over each discrete space.

10. The calendar of claim 8, wherein each label includes at least two stacked labels disposed over each discrete space.

11. A calendar comprising:
a rectangular backing sheet made of relatively flexible material;
a plurality of rectangular calendar sheets made of relatively flexible material, all of said calendar sheets being of substantially the same size as said backing sheet, each calendar sheet representing one month of the year;
means fastening all said sheets together along one edge thereof, whereby said one edge may be utilized for suspending the calendar;
each of said calendar sheets having individual date spaces arranged in vertical columns and horizontal rows to provide the dates for one month;
a plurality of labels adapted to be releaseably adhered to each of said individual date spaces, each label fitting within one of said individual date spaces, each said label configured to impart a duplicate image upon said corresponding individual date space of said calendar page when written upon with a writing implement.

12. The calendar of claim 11, further comprising a separate page for each month.

13. The calendar of claim 11, wherein each of said plurality of labels is a pressure-sensitive copying paper.

14. The calendar of claim 13, wherein each of said plurality of labels includes a pressure sensitive adhesive on at least a portion of a back surface of each label.

15. The calendar of claim 11, wherein each calendar page comprises a backing layer forming a rear layer of the page and a front layer defining the plurality of labels, wherein the front layer includes an adhesive rear surface and is divided into the plurality of discrete spaces by lines of perforation.

16. The calendar of claim 1, wherein each of the plurality of labels includes preprinted blank lines and associated check boxes to define a to-do list, wherein upon a user writing on each preprinted blank line of a particular label, a substantially identical copy of the user-defined to-do list is transferred to the individual date space of the calendar sheet underneath the particular label.

17. The calendar of claim 16, wherein each label includes at least two stacked labels disposed over each individual date space to create multiple records of the user-defined to-do list.

18. A calendar comprising:
at least one calendar page each having indicia thereon defining at least one month of the calendar year;
the at least one calendar page comprises a two-ply form including a face stock having top and bottom surfaces, a release liner of the same size and shape as the face stock and underlaying the face stock and adhesive on the bottom surface of the face stock releasably securing the face stock to the release liner;
the face stock and liner being of such material that upon writing information on said face with a writing implement, a copy of that information is simultaneously made on said liner;
wherein the face stock includes a label for each day of the month defined by a plurality of horizontal and vertical cuts through the face stock so that each individual day label is removable from the release liner and the remainder of the face stock;
each individual day label having date indicia on the front side thereof and a corresponding date indicia is disposed on the liner directly underneath the individual day label.

19. The calendar of claim 18, wherein each individual day label includes preprinted blank lines and associated check boxes to define a to-do list, wherein upon a user writing on each preprinted blank line of a particular individual day label, a substantially identical copy of the user-defined to-do list is transferred to the liner underneath the particular individual day label.

20. The calendar of claim 18, wherein the at least one calendar page includes a three-ply form including two layers of face stock wherein each layer of face stock includes a label for each day of the month defined by a plurality of horizontal and vertical cuts through the two layers of face stock so that two individual day labels are removable from the release liner and the remainder of the face stock.
